(19) United States
(12) Patent Application Publication
(10) Pub. No.: US 2011/0321015 A1
(43) Pub. Date: Dec. 29, 2011

(54) HARDWARE TRIGGERING MECHANISM FOR SOFTWARE DEBUGGER

(76) Inventor: Yen Hsiang Chew, Georgtown (MY)

(21) Appl. No.: 12/821,587

(22) Filed: Jun. 23, 2010

(51) Int. Cl. G06F 9/44; G06F 13/24

(52) U.S. Cl. 717/127; 710/260

(57) ABSTRACT

Embodiments of the invention utilize a signal analyzer to monitor a data path, the data path to include a plurality of transactions to be executed via a processor. The signal analyzer may further identify data of a first and a second transaction from the plurality of transactions. Transaction replication logic operatively coupled to the signal analyzer may generate a replicate transaction from the first transaction in response to the signal analyzer identifying the data of the first transaction, the replicate transaction to be stored in a memory. An interrupt generator operatively coupled to the signal analyzer may send an interrupt to the processor in response to the signal analyzer identifying at least the data of the second transaction, the processor to halt the execution of transactions and to pass control of execution of the second transaction to a debugging module in response to receiving the interrupt.

### FIELD

Embodiments of the invention generally pertain to system debugging, and more particularly, to setting hardware-based breakpoints based on transactions observed on a data path of a system.

### BACKGROUND

During the design and operation of a system, obtaining data describing the state of the system and system components (i.e., the data the system is processing) is necessary to determine and ensure proper functionality.

An input/output (I/O) or memory mapped transaction to a peripheral device (such as PCI Express, USB and SATA/SAS) is initiated as a transaction (or a series of transactions) on a bus of the system. The target peripheral device intercepts a transaction based on transaction data observable from the bus, e.g., the transaction type and the destination address of the transaction.

For data transmitted on the bus of a system to be accessed or probed, the use of an external device, e.g., a logic analyzer, is required. The logic analyzer must be physically coupled to the system via a series of pins. The system must also be designed to have bus data observable on these series of pins. The logic analyzer must be connected to the system bus while the transactions is observable on the bus.

Furthermore, in order to analyze a specific state of the system and system components during execution of a transaction, the execution of the system must be halted. Software, such as a software debugger, may halt the execution flow of the software under debug when a software break point is reached. Thus, to properly analyze the contents of a bus and the context of a system, coordination between system software and the logic analyzer is required.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of system including an embodiment of an invention.

FIG. 2 is a block diagram of an embodiment of the invention.

FIG. 3 is a flow diagram of a process utilizing an embodiment of the invention.

FIG. 4 illustrates a system transaction sequence and contents of a system memory according to an embodiment of the invention.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DESCRIPTION

Embodiments of the invention are directed towards monitoring a bus connecting the components of a system (e.g., a backbone bus) for transactions and interrupting a system processor when user specified transaction data is observable on the backbone bus.

In response to receiving an interrupt, the processor may pass control to a software debugger. The software debugger may then halt execution flow of system software, similar to a software debugger responding to a debug breakpoint.

Embodiments of the invention may also replicate and store specific transactions observable on the backbone bus into system memory based on user specified transaction data observable on the backbone bus. Replicating transactions in this manner allows a software debugger to observe a real time image of the transactions that were present and/or recently processed by the system when a transaction breakpoint (i.e., user specified transaction data) is observed.

It is to be understood that by enabling a user to configure a transaction breakpoint in a system, in combination with replicating certain transactions to memory, allows a user to capture a “snapshot” of the most recent transactions to I/O Mapped or configuration mapped space present with a system the instant a user defined hardware transaction pattern occurs.

It is to be understood that user specified transaction data may include a specific transaction to appear on the backbone bus, or a series of transactions to appear on the bus to “trigger” a processor interrupt and/or initiate replication of backbone bus data. It is to be further understood that the trigger to interrupt the system processor and the trigger to begin replicating backbone bus data may or may not be the same transaction data.

For example, embodiments of the invention may provide a debug capability for a system software debugger and a device driver by enabling a user to set system breakpoints based on real time hardware events. This capability, for example, enables real time debugging of software drivers by storing data related to a software driver's interaction with its respective hardware components, and by passing control to the system software debugger based on transaction bus data (i.e., hardware data), rather than limiting breakpoints to be based on software breakpoints as is known in the art (e.g., contents of registers or system memory).

Embodiments of the invention may include a signal analyzer to monitor a data path, the data path to include a plurality of transactions to be executed via a processor. The signal analyzer may further identify the aforementioned “triggers” from the plurality of transactions. Thus, the signal analyzer is capable of observing at least some of the data on the backbone bus (e.g., it may only be necessary for the signal analyzer to address a subset of backbone bus data if the triggers are to be based solely on the type and the target address of the transaction and this data is consistently with a specific bit range of the backbone bus).

In one embodiment, transaction replication logic may be operatively coupled to the signal analyzer to generate a replicate transaction from an original transaction in response to the signal analyzer identifying the appropriate trigger, wherein the replicate transaction is to be stored in a memory. Thus, embodiments of the invention may enable the storage of bus data, similar to that of a logic analyzer. In one embodiment, the transaction replication logic may modify the address to the replicated transaction to be directed towards memory, rather than whatever device the original transaction is directed towards. Thus, both the original and replicated transaction will be released on the backbone bus, and processed accordingly.

For example, the signal analyzer may be configured to detect specific transaction types or address ranges (e.g., non-PCI address ranges). When this component detects these transactions on the backbone bus, it may notify the transaction replication logic to replicate the transaction and change the address field of the replicate transaction to a memory controller (e.g., a DDR controller), so that the memory controller will write the data portion of that transaction to a memory region (e.g., included in DDR memory) pre-specified by the user. The original transaction that appears on the backbone bus remains untouched so that it will reach its intended target. Thus, it is to be understood that system devices are “unaware” if any transactions are replicated.

In one embodiment, an interrupt generator may be operatively coupled to the signal analyzer to send an interrupt to the processor in response to the signal analyzer identifying the appropriate trigger. In response to receiving the interrupt, the processor may halt the execution of transactions and pass control of execution of subsequent transactions to a debugging module in response to receiving the interrupt. Thus, it is to be understood that embodiments of the invention enable real-time debugging of system hardware and software without requiring the use of external hardware or coordination between external hardware and a system software debugger.

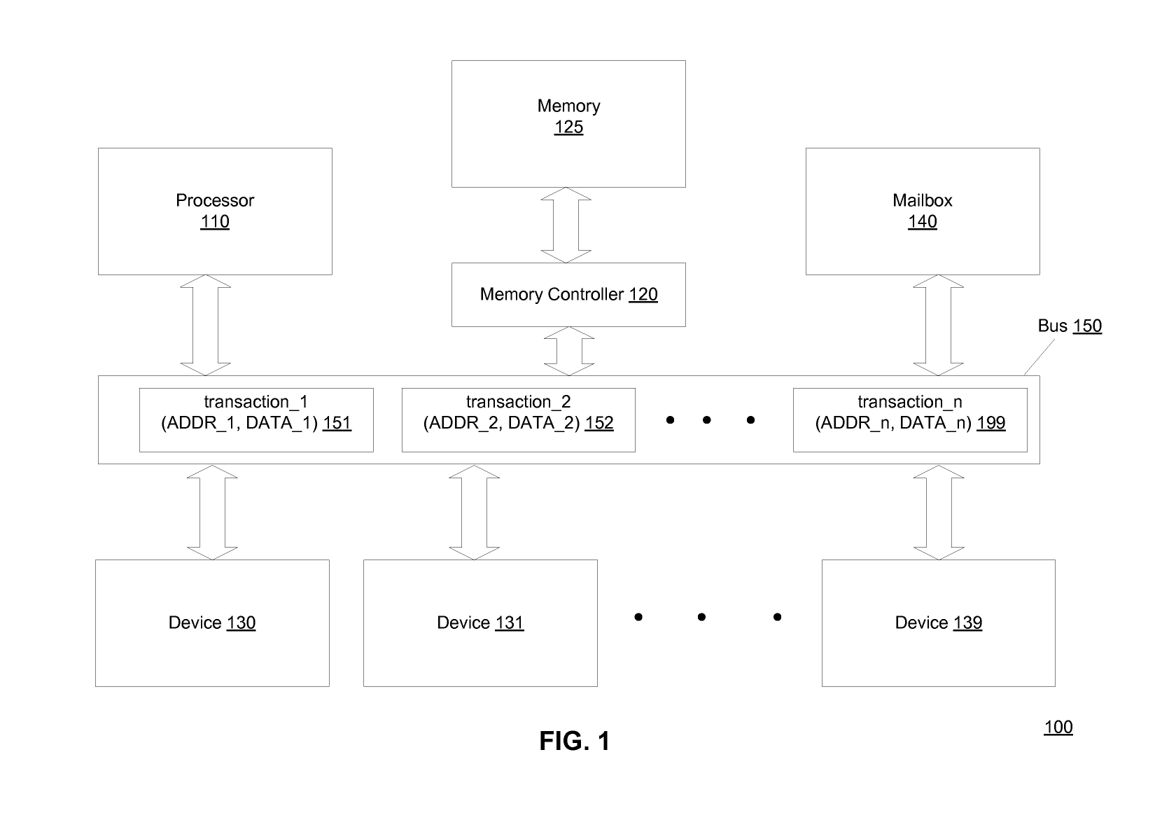

FIG. 1 is a block diagram of system including an embodiment of an invention. System 100 may be included in a desktop computer device, a mobile computer device, or any other any device utilizing a processor and system memory.

System 100 may include processor 110, memory controller 120 (further coupled to memory 125), and devices 130-139. Each of the aforementioned components of the system may be operatively coupled via bus 150, wherein said bus is used by the components as a communication transport mechanism.

Bus 150 may include a series of transactions, including transaction_1 151, transaction_2 152, through transaction_n 199. System 100 further includes mailbox 140 interfaced with bus 150. Mailbox 140 may be any module or logic to observe at least some of the transaction data present on bus 150.

In this illustrated embodiment, real time debugging software executing on system 100 may be enabled based on transactions to any one of devices 130-139. It is to be understood that, as described above, mailbox 140 may behave similar to a logic analyzer; mailbox 140 is programmed to capture backbone transactions by replicating them and directing the replications to memory controller 120 (e.g., a DDR controller) to be stored in memory 125 (e.g., DDR memory) when a sequence of transactions is observed on bus 150. For example, mailbox 140 may be configured to replicate bus transactions when it sees transaction_1 151 and transaction_2 152 on backbone bus 150 (e.g., transactions from transaction_2 152 to transaction_n 199 may be replicated). Mailbox 140 may identify the transactions 151 and 152 by address (ADDR_1, ADDR_2) and data payload (DATA_1, DATA_2).

It is to be understood that mailbox 140 may further decode bus transaction patterns and assert an interrupt to processor 110 when a user predefined pattern is observed. When a processor is interrupted, processor may halt the execution flow of the software under debug and pass control to the software to a system software debugger.

Mailbox 140 may be configured to interrupt processor 110 when it detects a specific transaction or transaction pattern on the backbone bus. For example, mailbox 140 may be configured to interrupt processor 110 when it sees transaction_n 199 on backbone bus 150. Mailbox 140 may identify transaction_n 199 by any one of transaction type, transaction address (ADDR_n) and data payload (DATA_n).

Control of software executing on system 100 may be passed to software debugger when the desired condition is reached. The ability for mailbox 140 to interrupt processor 110 upon detecting a user predefined transaction pattern on the backbone bus achieves real time debugging. Thus, mailbox 140 may be linked to a conventional user debugger to enable real time debugging of software drivers, enabling a user to trigger an internal capture of various bus signals in memory 125 and halt the debugger when a hardware condition is reached.

Transaction patterns that cause mailbox 140 to replicate transactions into system memory 125 and to interrupt processor 110 may be configurable in real time. In one embodiment, a specific transaction type may exist to trigger the replication of transactions and to interrupt processor 110.

Furthermore, a specific transaction type may exist to halt replication of transactions on bus 150. This instruction may be a processor instruction issued to mailbox 140 if the mailbox needs to be halted in response to a software breakpoint (instead of an observed transaction on bus 150). The software breakpoint could halt mailbox 140 by issuing a halt instruction. This example embodiment would allow a user of system 100 to mix software and hardware breakpoints for controlling mailbox 140 and the capture of transactions on bus 150.

While the above embodiment illustrated in FIG. 1 utilizes transaction data for triggering replication and interrupt operations, it is to be understood that triggers for said operations may comprise any data on bus 150 that mailbox 140 is capable of viewing (e.g., the target device of a transaction, time data or any system related data present on bus 150 that is not directed related to a transaction). In another embodiment, triggering replication and interrupt operations may comprise any data that is accessible by mailbox 140, but not necessarily bus data (e.g., system information, control signals, time data).

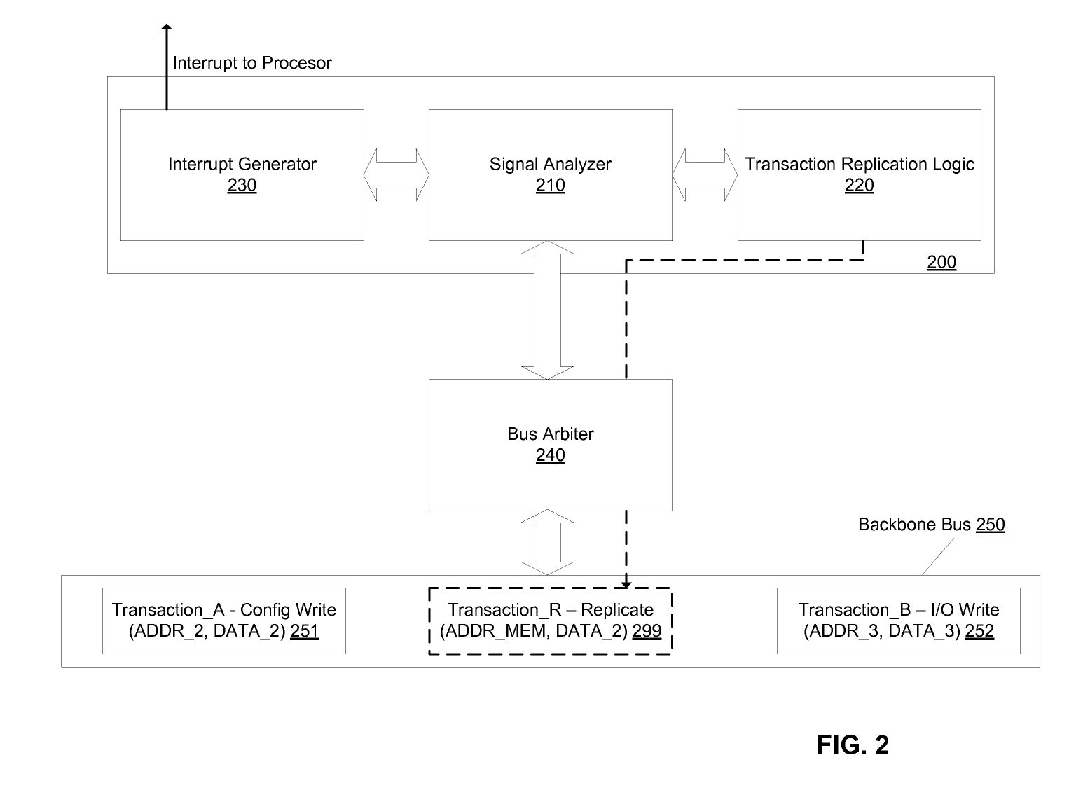

FIG. 2 is a block diagram of an embodiment of the invention. Mailbox 200 operates in a manner similar to that of mailbox 140 in FIG. 1. Mailbox 200 includes signal analyzer 210. Transaction replication logic 220 may be operatively coupled to signal analyzer 210. Interrupt generator 230 may be operatively coupled to signal analyzer 210.

In one embodiment, mailbox 200 may replicate the transactions (with the exception of the address field, where instead the replicated transaction is targeted to a memory controller) when a desired transaction type and address range is detected.

In this embodiment, mailbox 200 is coupled to bus arbiter 240, which is further coupled to bus 250. Bus arbiter 240 may coordinate the transmission of transactions across bus 250 according to availability of the processor(s), availability of devices, or transaction type.

Transaction_A 251 and Transaction_B 252 are illustrated to be transmitted via bus 250. Bus arbiter 240 may pass at least a portion of the information included in a transaction to signal analyzer 210. For example, bus arbiter may pass data indicating the destination address of each transaction or the transaction type of each transaction.

In one embodiment, signal analyzer 210 may be programmed to trigger transaction replication logic 220 to replicate transactions into memory based on a user defined transactions pattern. Signal analyzer 210 may received some or all of transaction data that appears on bus 250 via bus arbiter 240. In this embodiment, transaction replication logic 220 is triggered to replicate Transaction_A 251 as Transaction_R 299. The address of Transaction_R is targeted to system memory, while the remaining transaction data (e.g., DATA_2) remains consistent with Transaction_A 251. In one embodiment, the address of Transaction_A 251 (ADDR_2) may be included in the data payload of Transaction_R, thus allowing a user to view the address of the original transaction. Transaction_R is then transmitted to bus arbiter 240 to be placed on backbone bus 250.

Upstream transactions from devices to the system processor may also be observed and used as triggers by observing/receiving signals from backbone internal bus arbiter 240. This may be accomplished by pulling out some upstream bus and control signals from the backbone bus arbiter unit to signal analyzer 210.

Interrupt generator 230 may also be configured by to interrupt the system processor upon signal from signal analyzer 210. Signal analyzer 210 may signal interrupt generator 230 upon observing after a sequence of events. In this embodiment, signal analyzer 210 is programmed to signal interrupt generator 230 to interrupt the system processor when Transaction_A 251 (sending a configuration write to address ADDR_2 with data DATA_2) is followed by Transaction_B 252 (an I/O write to address ADDR_3 to DATA_3).

In another embodiment, interrupt generator 230 utilizes other system related data to interrupt the system processor. For example, a specific time lapse value (alone, or in combination with other data accessible by signal analyzer 210) may be used to determine when to generate an interrupt to the system processor.

It is to be understood that interrupt generator 230 may send an interrupt to the processor via any means known in the art. For example, interrupt generator 230 may assert a line coupled to the system processor. In another embodiment, interrupt generator may generate a message signaled interrupt to cause the system to interrupt the processor. In another embodiment, interrupt generator 230 may send an interrupt to processor using a sideband signal.

Thus, it is to be understood that the breakpoint described above (i.e., the sequence of Transaction_A 251 and Transaction_B 252) is not directly related to software executing on the system (i.e., contents of an allocated register or item in memory) but rather specific data present on backbone bus 250. Furthermore, while the illustrated in this embodiment includes Transaction_A and Transaction_B as consecutive transactions, it is to be understood that the breakpoint described above may be a sequence of non-consecutive transactions.

In one embodiment, the system processor will observe the interrupt generated by interrupt generator 230 and pass control to a software debugger. The system processor may also halt the execution flow of software executing on the system to enable a user to peek into software component variables and peek at replicated transactions stored inside DDR controller (i.e., transactions replicated by transaction replication logic 220).

After a condition is hit and software execution flow is halted, a system user may reprogram mailbox 200 to look for a different transaction pattern and restart the software execution flow from where it was previously halted.

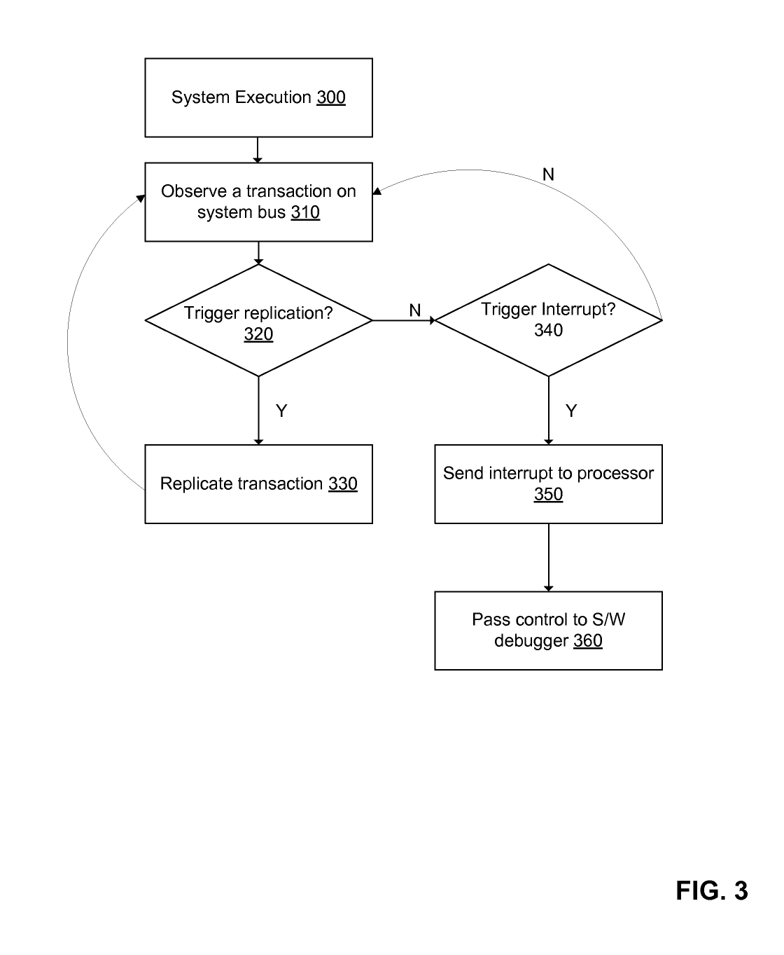

FIG. 3 is a flow diagram of a process utilizing an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

A system executes an operating system, the operating system further executing a plurality of applications, 300. Transactions are observed on the system bus, 310. It is determined if a transaction on the bus is a “trigger” to start replicating transactions in order to store them in memory, 320. For example, non-memory mapped transactions observed on the bus may be used as a trigger to begin replicating system transactions.

If a transaction is observed that is to be replicated, transaction replication logic may be executed to replicate the transaction, 330. In one embodiment, the transaction is replicated with the exception of the destination address of the original transaction, which may be changed to address the replicated transaction to memory or a memory controller. In one embodiment, the destination address of the original transaction may be included in the data payload of the replicated transaction, thus allowing a user to view the address of the original transaction.

Thus, up-to-date images of transactions appearing on the system bus are stored in memory. This memory may be accessed or output (i.e., dumped) at a later time for debug or when a debug trigger (i.e., break point) is reached. A user is able to specify the desired real time hardware conditions for triggering their software debugger.

If the observed transaction is does not trigger transaction replication, it is then determined if the transaction observed is a trigger for a processor interrupt, 340. If the transaction is the trigger, than an interrupt generator is notified to interrupt the processor, 350. The processor is interrupted and control of execution for system software under debug (e.g., a device driver) is passed to a system software debugger, 360. Thus, a trigger for transaction replication and software debug execution may be configured for any types of transactions to any address ranges targeted to any system devices. Both upstream and downstream bus transactions may be used as logic analyzer triggers for interrupting processor and for initializing bus data replication into memory.

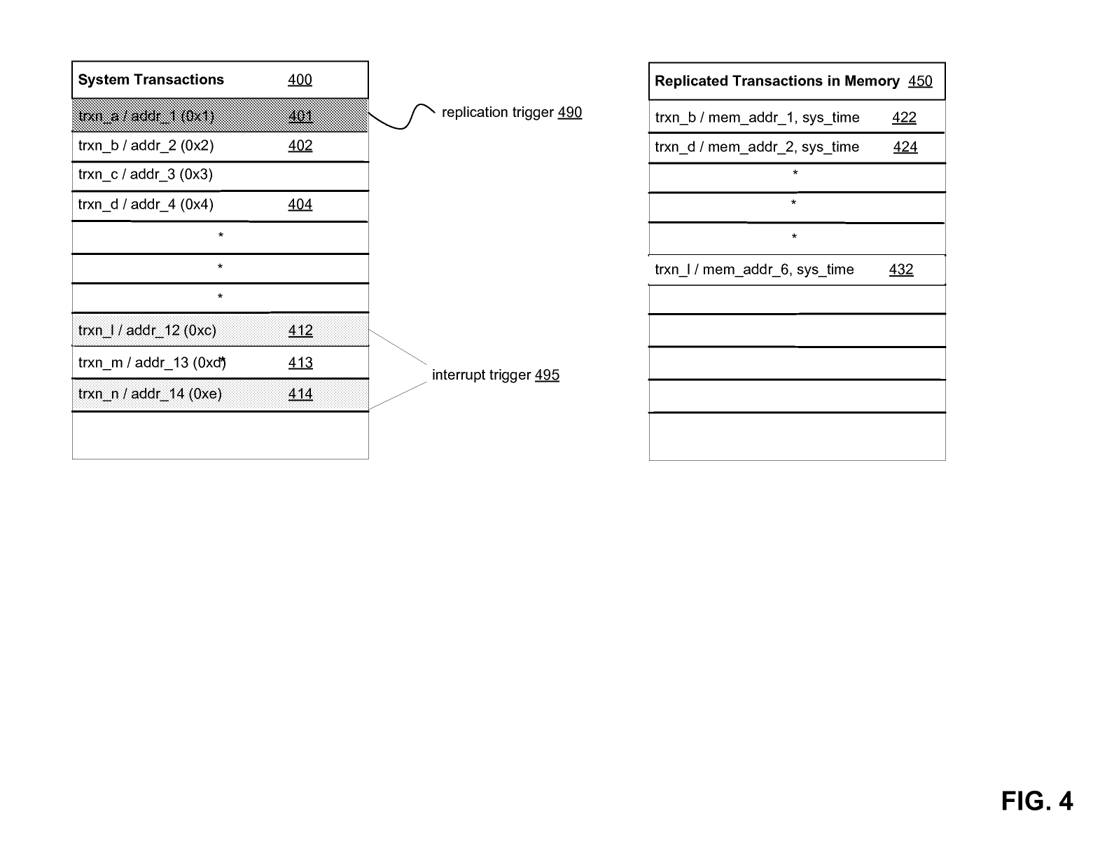

FIG. 4 illustrates a system transaction sequence and contents of a system memory according to an embodiment of the invention. Transaction sequence 400 is series of transactions to appear on a backbone bus of a system. In transaction sequence 400, a transaction to address 0x1 will serve as replication trigger 490 to trigger the replication of transactions on the backbone bus (i.e., trxn_a 401). In this embodiment, replication logic is configured such that only transactions to even numbered addresses will be replicated and stored in memory. Thus, replicated transactions 450 includes replicated transaction 422 of trxn_b 402 (to address 0x2), replicated transaction 424 of trxn_d 404 (to address 0x4) and so forth. In this embodiment, each transaction further includes a time field indicating the system time when the respective transaction was issued on the backbone bus.

In this embodiment, a series of transactions to addresses 0xd and 0xe (i.e., trxn_1 412 and trxn_n 414) serve as interrupt trigger 495 to trigger an interrupt of the system processor. Because execution of the system processor is interrupted, trxn_1 412 is replicated and stored as transaction 432, while trxn_n is not replicated and thus not stored within replication transactions 450 (even though it meets the aforementioned criteria of being a transaction to an even numbered address). In another embodiment, trnx_n may be replicated and stored within replication transactions 450 prior to the interrupt of the system processor.

In one embodiment, when the system processor is interrupted, the processor is placed in a halted state, and replicated transactions 450 may be read and displayed to user through an interface with their respective time field.

Thus, embodiments of the invention enables system users to effectively debug system software by storing important state information of non-memory typed transactions. Embodiments of the invention further allow system users to observe the stored state information when a user defined condition occurs. For example, embodiments of the invention allow for enhanced debug capabilities of device drivers by storing important state information of the various I/O mapped transactions to the respective device.

The ability to provide additional debug capabilities to system users and developers will reduce software and driver development time, and thus reduce development time and costs. The ability for users to effectively debug software and devices further increases reliability and enhances debug efforts without requiring additional hardware external to the system and dedicated output pins to transmit debug data.

Various components referred to above as processes, servers, or tools described herein may be a means for performing the functions described. Each component described herein includes software or hardware, or a combination of these. The components can be implemented as software modules, hardware modules, special-purpose hardware (e.g., application specific hardware, ASICs, DSPs, etc.), embedded controllers, hardwired circuitry, etc. Software content (e.g., data, instructions, configuration) may be provided via an article of manufacture including a computer storage readable medium, which provides content that represents instructions that can be executed. The content may result in a computer performing various functions/operations described herein. A computer readable storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable storage medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

1. An apparatus comprising:
a signal analyzer to
monitor a data path, the data path to include a plurality of transactions to be executed via a processor, and
identify data of a first and a second transaction from the plurality of transactions;
transaction replication logic operatively coupled to the signal analyzer to generate a replicate transaction from the first transaction in response to the signal analyzer identifying the data of the first transaction, the replicate transaction to be stored in a memory; and
an interrupt generator operatively coupled to the signal analyzer to send an interrupt to the processor in response to the signal analyzer identifying at least the data of the second transaction, the processor to halt the execution of transactions and to pass control of execution of the second transaction to a debugging module in response to receiving the interrupt.

2. The apparatus of claim 1, the transaction replication logic to further generate a replicate transaction to be stored to the memory from a transaction included in the data path between the first and second transaction.

3. The apparatus of claim 1, the interrupt generator to send the interrupt to the processor in response to the signal analyzer identifying data from a sequence of transactions including the data of second transaction.

4. The apparatus of claim 1, the interrupt generator to send the interrupt to the processor in response to the signal analyzer identifying the second transaction and a time lapse value expiring.

5. The apparatus of claim 1, the data of first and second transactions to identify at least one of a transaction type of each transaction, an address field included in each transaction, data included in a data payload of each transaction, and control signals associated with each transaction.

6. The apparatus of claim 1, wherein the transaction replication logic further includes a time field in each replicated transaction, the time field to indicate the time the respective transaction was monitored on the data path by the signal analyzer.

7. The apparatus of claim 1, wherein the memory to store the replicate transaction is included in the apparatus.

8. The apparatus of claim 1, wherein the memory to store the replicate transaction is included in a memory device operatively coupled to the apparatus.

9. A method comprising:
monitoring a data path, the data path to include a plurality of transactions to be executed via a processor;
identifying data of a first and a second transaction from the plurality of transactions;
generating a replicate transaction from the first transaction in response to the signal analyzer identifying the data of the first transaction, the replicate transaction to be stored in a memory; and
sending an interrupt to the processor in response to the signal analyzer identifying at least the data of the second transaction, the processor to halt the execution of transactions and to pass control of execution of the second transaction to a debugging module in response to receiving the interrupt.

10. The method of claim 9, further comprising generating a replicate transaction to be stored to the memory from a transaction included in the data path between the first and second transaction.

11. The method of claim 9, wherein sending the interrupt to the processor is in response to identifying data from a sequence of transactions including the data of second transaction.

12. The method of claim 9, wherein generating the replicate transaction and sending the interrupt to the processor is further in response to identifying non-transaction related data.

13. The method of claim 9, wherein the data of first and second transactions identifies at least one of a transaction type of each transaction, an address field included in each transaction, data included in a data payload of each transaction, and control signals associated with each transaction.

14. A system comprising:
a processor;
a memory;
a plurality of devices;
a command mailbox; and
a bus to operatively couple the processor, the memory, the plurality of devices and the command mailbox and to include a plurality of transactions each directed to one of the plurality of devices, the command mailbox to further include
a signal analyzer to monitor the bus and to identify data of a first and a second transaction from the plurality of transactions,
transaction replication logic operatively coupled to the signal analyzer to generate a replicate transaction from the first transaction in response to the signal analyzer identifying the data of the first transaction, the replicate transaction to be stored in a memory, and
an interrupt generator operatively coupled to the signal analyzer to send an interrupt to the processor in response to the signal analyzer identifying at least the data of the second transaction, the processor to halt the execution of transactions and to pass control of execution of the second transaction to a debugging module in response to receiving the interrupt.

15. The system of claim 14, the transaction replication logic to further generate a replicate transaction to be stored to the memory from a transaction included in the data path between the first and second transaction.

16. The system of claim 14, the interrupt generator to send the interrupt to the processor in response to the signal analyzer identifying data from a sequence of transactions including the data of second transaction.

17. The system of claim 14, the interrupt generator to send the interrupt to the processor in response to the signal analyzer identifying the second transaction and a time lapse value expiring.

18. The system of claim 14, the data of first and second transactions to identify at least one of a transaction type of each transaction, an address field included in each transaction, data included in a data payload of each transaction, and control signals associated with each transaction.

19. The system of claim 14, wherein the transaction replication logic further includes a time field in each replicated transaction, the time field to indicate the time the respective transaction was monitored on the data path by the signal analyzer.

20. The system of claim 19, the processor to be placed in a halted state in response to receiving the interrupt, wherein replicate transactions stored in memory may be displayed via a debugging interface included in the system based on the time field of each respective replicated transaction.
